(19) United States
(12) Patent Application Publication
(10) Pub. No.: US 2012/0119681 A1
(43) Pub. Date: May 17, 2012

(54) LIGHT DEVICES AND SYSTEMS

(75) Inventors: Ken Seidl, Port Washington, WI (US); Edward Nowak, West Bend, WI (US); Paul Li, Milwaukee, WI (US)

(73) Assignee: RAFFEL SYSTEMS, LLC, Germantown, WI (US)

(21) Appl. No.: 12/946,682

(22) Filed: Nov. 15, 2010

(51) Int. Cl. H05B 37/00

(52) U.S. Cl. 315/362

(57) ABSTRACT

The present invention provides switches and sensors that automatically turn on and/or off an associated device. In particular, the present invention provides lighting devices containing switches and sensors associated with the device that power/depower the device and systems and objects containing the device.

### FIELD OF THE INVENTION

The invention provides switches and sensors that automatically turn on and/or off an associated device. In particular, the present invention provides lighting devices containing switches and sensors associated with the device that power/depower the device and systems and objects containing the device.

### BACKGROUND

A variety of installed lighting applications involve lights which are concealed when not in active use, for example, within a compartment or behind a portion of an object within which they are installed. Safety issues arise regarding installed lighting when lights remain “on” when in the concealed position. Heat can build-up surrounding the concealed light creating a fire hazard. This is particularly dangerous when lights are installed in furniture, bedding, seating arrangements or vehicles, as human occupants are placed at risk from fire. Mechanical switches that rely on a user to manually turn off the light do not completely alleviate the danger, as human operators frequently neglect to switch off the light prior to stowing it.

### SUMMARY OF THE INVENTION

The invention provides lighting devices containing switches and sensors associated with the device that power/depower the device and systems and objects containing the device. In some embodiments, the present invention provides a stowable light fixture comprising: (a) a housing component; (b) a light component, wherein the light component is configured to adopt: (i) a stowed configuration in which the light component is contained within the housing, and (ii) an active configuration in which the light component is extended from the housing; and (c) a switch component, wherein the switch component is configured to: (i) depower the light component when the light component adopts a stowed configuration, and (ii) activate the light component when the light component adopts an active configuration. The present invention is not limited to any particular switch component. Indeed, a variety of switch components find use in a device and/or system of the invention including, but not limited to, a Hall-Effect device, proximity sensor, optical sensor, audio sensor, IR sensor, inclinometer, or accelerometer. In some embodiments, the switch component does not comprise a mechanical switch. In some embodiments, depowering the light component upon stowage turns off the light component. In some embodiments, activating the light component upon extension from the housing component turns on the light component. In some embodiments, powering the light component upon extension from the housing component enables the light component to be turned on and off by another device. In some embodiments, the housing component is configured for integration into an object. In some embodiments, the object is furniture. In some embodiments, the object is a vehicle.

In some embodiments, the invention provides an apparatus comprising: (a) a light, wherein the light is configured to adopt a stowed configuration within the apparatus and an active configuration extended from the apparatus; and (b) a configuration-dependent switch, wherein the configuration-dependent switch depowers the light upon adopting the stowed configuration. In some embodiments, depowering the light comprises turning off the light. In some embodiments, the configuration-dependent switch activates the light upon adopting the active configuration. In some embodiments, activating the light comprises turning on the light. In some embodiments, the apparatus is a piece of furniture. The present invention is not limited by a type of furniture in which an apparatus of the invention is housed. The furniture can be any type of furniture including, but not limited to, a chair, couch, theater seating, bed, table, shelf, and/or book case. In some embodiments, the apparatus is a vehicle. The present invention is not limited by a type of vehicle. Indeed a variety of vehicles may utilized a lighting device or system of the invention including, but not limited to, a car, truck, plane, boat, or train. In some embodiments, the configuration-dependent switch is a mechanical switch, Hall-Effect device, proximity sensor, optical sensor, audio sensor, IR sensor, inclinometer, or accelerometer. In some embodiments, the configuration-dependent switch does not comprise a mechanical switch.

### BRIEF DESCRIPTION OF THE DRAWINGS

The foregoing summary and detailed description is better understood when read in conjunction with the accompanying drawings which are included by way of example and not by way of limitation.

FIG. 1 shows a flexible-neck light fixture with a mechanical switch.

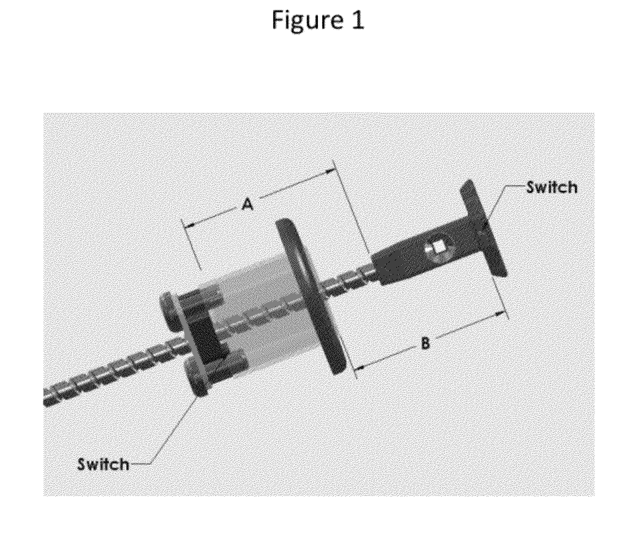

FIG. 2 shows a flexible-neck light fixture with a Hall-Effect switch.

FIG. 3 shows a dual-light fixture head with a proximity-sensor.

FIG. 4 shows a single-light fixture head with a capacitive-touch sensor.

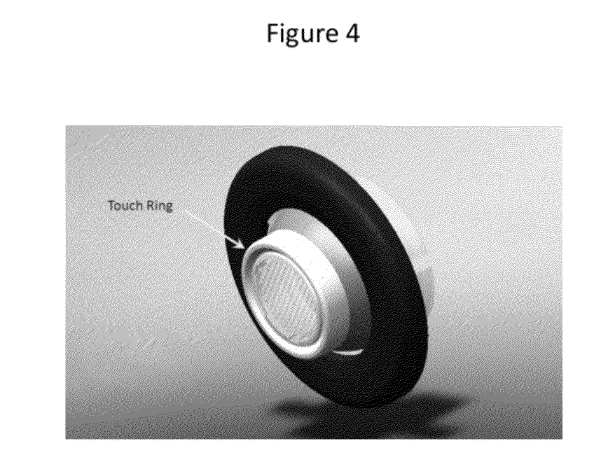

### DETAILED DESCRIPTION OF EMBODIMENTS OF THE INVENTION

The present invention provides switches and/or sensors that automatically turn on and/or off an associated device (e.g. light), and methods of use thereof. In particular, the present invention provides switches and sensors associated with a device that power/depower an associated device upon deployment/storage. The present invention provides switching mechanisms which automatically turn on and/or off an associated device (e.g. light (e.g. installed light, mounted light, etc.)). In some embodiments, the present invention provides a position- or configuration-dependent switching mechanism. In some embodiments, a switching mechanism is provided that automatically turns off an associated device (e.g. light (e.g. installed light, mounted light, etc.)) upon placing that device in a stowed or retracted configuration. In some embodiments, a switching mechanism is provided that automatically turns on an associated device (e.g. light (e.g. installed light, mounted light, etc.)) upon placing that device in an extended or deployed configuration. In some embodiments, a switching mechanism is associated with, attached to, integrated with, connected to, and/or a part of a lighting device (e.g. installed light fixture, concealable light fixture, etc.). In some embodiments, the present invention provides a stowable and/or concealable light fixture configured with an automatic switching mechanism. In some embodiments, an automatic switching mechanism turns off an associated light fixture upon placing the light fixture into a concealed, storage, and/or inactive position. In some embodiments, a switching mechanism is automatically actuated by the motion associated with stowing or concealing the associated device (e.g. light fixture). In some embodiments, a switching mechanism comprises a mechanical switch, Hall Effect device, proximity sensor, sonar sensor, inductive sensor, capacitive sensor, optical sensor, infra-red sensor, inclinometer, and/or accelerometer.

In some embodiments, the present invention provides a concealable, stowable, and/or retractable device (e.g. light). In some embodiments, the device (e.g. light fixture) is installed, mounted, connected, attached, and/or configured to an object (e.g. piece of furniture (e.g. chair)), apparatus, or element. In some embodiments, a device is installed in furniture (e.g. chair, desk, bed, book case, dresser, etc), seating arrangements (e.g. theater seating, conference seating, etc.) and/or a vehicle (e.g. car, truck, boat, plane, train, etc.). In some embodiments, when installed and/or mounted in/on a chair, couch, or other form of seating, a light is mounted on the arm rest, head rest, side of chair, console area between seats, etc. In some embodiments, when installed and/or mounted in/on vehicle (e.g. car, truck, boat, plane, train, etc.), a light is mounted on the dashboard, overhead, on a console, on a door, on an armrest, along the seat back, etc.

In some embodiments, a device (e.g. light) mounted in/on an object is configured to adopt multiple conformations (e.g. concealed and exposed, active and inactive, stowed and deployed, retracted and extended, concealed and revealed (e.g. under a cover), etc.). In some embodiments, a device is configured to adopt multiple intermediate conformations (e.g. partially extended). In some embodiments, a device (e.g. light) is configured to adopt discrete intermediate positions. In some embodiments, a device (e.g. light) is configured to adopt any position between fully extended and fully retracted.

In some embodiments, the present invention provides a switch or sensor which turns a device (e.g. light) on and off, when the device is moved from one conformation to another. In some embodiments, a switch mechanism shuts off a device (e.g. light) when the device is placed in a concealed, inactive, stowed, and/or retracted conformation. In some embodiments, a switch or sensor prevents a device (e.g. light) from being turned on when in a concealed, inactive, stowed, and/or retracted conformation. In some embodiments, a concealed, inactive, stowed, and/or retracted device (e.g. light) is depowered by a switch mechanism.

In some embodiments, the present invention provides a switch or sensor which turns a device (e.g. light) on and off, when a cover is placed over the device to partially or fully cover and/or enclose the device. In some embodiments, a switch mechanism shuts off a device (e.g. light) when the cover places the device in a concealed, inactive, stowed, and/or retracted conformation. In some embodiments, a switch or sensor prevents a device (e.g. light) from being turned on when in a concealed, inactive, stowed, and/or retracted conformation. In some embodiments, a concealed, inactive, stowed, and/or retracted device (e.g. light) is depowered by a switch mechanism.

In some embodiments, a device (e.g. light) and cover function in concert. In some embodiments, movement of a cover into an open position results in extension of the associated device. In some embodiments, movement of a cover into a closed position results in retraction of the associated device. In some embodiments, the processes of (1) opening and closing of a cover, (2) extension and refraction of a device (e.g. light), and (3) activation and deactivation of the device (e.g. light) are coupled.

In some embodiments, a switch or sensor activates a device (e.g. light) when the device is placed in an exposed, active, deployed, and/or extended conformation. In some embodiments, a switch or sensor turns on a device when the device is placed in an exposed, active, deployed, and/or extended conformation. In some embodiments, a device (e.g. light) remains on until the device is stowed, retracted, concealed, etc. In some embodiments, a device (e.g. light) may be turned on or off when in an exposed, active, deployed, and/or extended conformation. In some embodiments, a switch or sensor of the present invention activates (e.g. provides power to) a device (e.g. light) when it adopts an active (e.g. extended, unstowed) configuration, but a second switch is used to turn a device on and off. In some embodiments, a switch or sensor of the present invention activates (e.g. provides power to) a light when it adopts an active (e.g. extended, unstowed) configuration, and a dimmer switch is provided to allow a user to select the degree of brightness. In some embodiments, a switch or sensor of the present invention deactivates (e.g. depowers) a device (e.g. light) when it adopts an inactive (e.g.

retracted, stowed) configuration.

In some embodiments, the present invention provides a mechanical switch. In some embodiments, the present invention provides a device (e.g. light) operated by a mechanical switch. In some embodiments, a mechanical switch turns a device on and off as the device moves between deployed and concealed (e.g. extended and retracted) conformations. In some embodiments, a mechanical switch is located on the housing of the light or other device and is tripped (e.g. on or off) by an element on the head of the light during deployment of retraction. In some embodiments, a mechanical switch is located on the head of the light or other device and is tripped (e.g. on or off) by an element on the housing of the light during deployment of retraction.

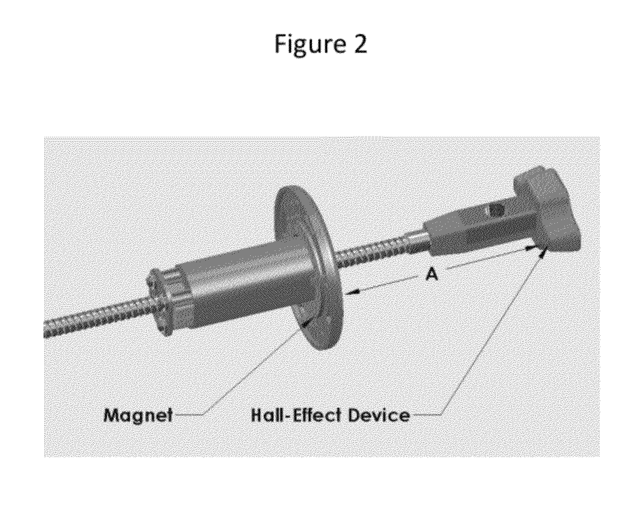

In some embodiments, the present invention provides a Hall Effect switch. In some embodiments, the present invention provides a device (e.g. light) operated by a Hall Effect switch. In some embodiments, a Hall Effect switch turns a device on and/or off as the device moves between deployed and concealed (e.g. extended and retracted) conformations. Any type of switch that detects and/or uses a Hall Effect voltage difference (the Hall voltage) across an electrical conductor, transverse to an electric current in the conductor and a magnetic field perpendicular to the current, can be utilized in a device of the invention. In some embodiments, a Hall Effect operated device comprises two components: (1) a Hall Effect sensor and (2) a magnet or electro-magnet (SEE FIG. 2). In some embodiments, when the distance between the Hall Effect sensor and the magnet is brought below a threshold distance, an associated device (e.g. light) is turned “off” or disabled. In some embodiments, when the distance between the Hall Effect sensor and the magnet exceeds the threshold distance, the associated device is switched “on” or enabled. The invention is not limited to a particular threshold distance, for example, the threshold distance can be set to any distance or dimension by changing the sensor or field strength of the magnet. The Hall Effect sensors provide a low-cost solid state sensor. Hall Effect sensors of various sizes, shapes, with or without amplifiers, and many different magnetic field requirements find use in embodiments of the present invention (e.g. customized for a particular application).

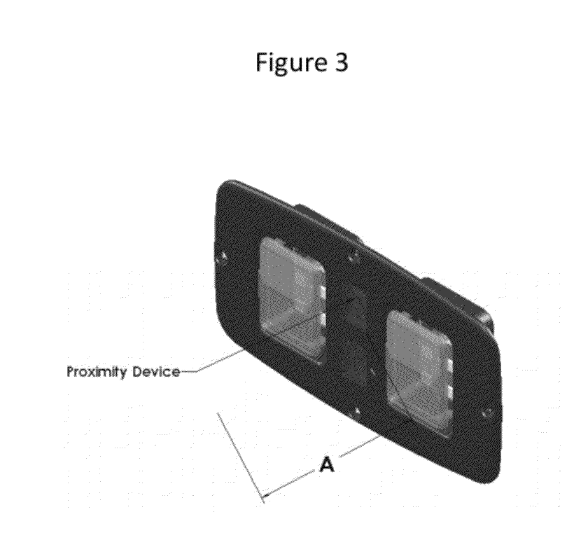

In some embodiments, the present invention provides a proximity sensor (e.g. inductive sensor, sonar sensor). In some embodiments, the present invention provides a device (e.g. light) operated by a proximity sensor. In some embodiments, a proximity sensor turns a device on and off as the device moves between deployed and concealed (e.g. extended and retracted) conformations. Proximity sensors that find use with the present invention are not limited detection through contact, for example, in some embodiments a proximity sensor is able to detect the presence of nearby objects without any physical contact (SEE FIG. 3). In some embodiments, a proximity sensor detects the presence of objects which penetrate the set threshold distance of the sensor. The proximity sensor is set to switch a device (e.g. light) “on” or “off” upon detecting an object within the threshold distance. Proximity sensors that find use with the present invention are not limited to any particular threshold distance, for example a threshold may be set to any required/desired distance. Different proximity sensors allow for different threshold distances. In some embodiments, a proximity sensor emits an electromagnetic or electrostatic field, or a beam of electromagnetic radiation (e.g. infrared), and detects changes in the field or return signal. Various methods of proximity can be used, including, but not limited to: sonar, acoustic signals, IR sensing, magnetic sensing, etc.

In some embodiments, the present invention provides a capacitive sensor. In some embodiments, the present invention provides a device (e.g. light) operated by a capacitive sensor. In some embodiments, a capacitive sensor turns a device on and off as the device moves between deployed and concealed (e.g. extended and retracted) conformations. In some embodiments, capacitive touch sensing comprises a sensor which is activated upon touching or approaching the surface of the sensor, resulting in a distortion of the sensors electrostatic field causing a change in capacitance. Upon detecting a change in the electrostatic field or capacitance, a signal is sent to switch on or off an associated device. In some embodiments, a timer function is incorporated to turn the light “OFF” a predetermined time after activation of the sensor.

In some embodiments, the present invention provides an optical sensor (e.g. photo cell, etc.). In some embodiments, the present invention provides a device (e.g. light) operated by an optical sensor. In some embodiments, an optical sensor turns a device on and off as the device moves between deployed and concealed (e.g. extended and retracted) conformations. In some embodiments, the presence of light or lack of light is used to switch the light on and off In some embodiments, the photo sensor turns the device off when no light is present (e.g. stowed position). In some embodiments, the photo sensor turns the device off when light is detected (e.g. extended position).

In some embodiments, the present invention provides an infrared sensing mechanism. In some embodiments, the present invention provides a device (e.g. light) operated by an infrared sensing mechanism. In some embodiments, an infrared sensing mechanism turns a device on and off as the device moves between deployed and concealed (e.g. extended and retracted) conformations. In some embodiments, an IR transmitter and IR receiver provide a signal connection indicating that the light fixture is in the stowed and/or deployed position. Extension of the light from the stowed position disrupts the IR signal connection and the light is turned on. Retraction of the fixture into the stowed position restores the IR signal connection and the light is again turned off.

In some embodiments, the present invention provides an inclinometer or accelerometer. In some embodiments, the present invention provides a device (e.g. light) operated by an inclinometer or accelerometer. In some embodiments, an inclinometer or accelerometer turns a device on and off as the device moves between deployed and concealed (e.g. extended and retracted) conformations. In some embodiments, the position or motion of the light fixture is used to turn the light on and off. Predefined positions and/or movements provide signals to turn the light on and/or off.

In some embodiments, a sensor (e.g. Hall Effect, proximity, optical, IR, etc.) or switch sends a signal to turn a device (e.g. light) on or off. In some embodiments, the signal sent by the sensor may be mechanical, electronic, or a combination thereof. In some embodiments, non-mechanical switch or sensor sends a non-mechanical signal to turn a device (e.g. light) on and/or off. In some embodiments, non-mechanical switch or sensor sends a mechanical signal to turn a device (e.g. light) on and/or off. In some embodiments, mechanical switch sends a non-mechanical signal to turn a device (e.g. light) on and/or off.

In some embodiments, the sensor or switch of the present invention provides a kill switch. In these embodiments, when a device (e.g. light) is in an extended position, the device (e.g. light) is operated (e.g. turned on and off) by a switch or control device. However, when the light is stowed, the sensor or switch of the present invention depowers (e.g. shuts off the power) the device (e.g. light), thereby ensuring the device (e.g. light) is off when in the stowed position. When the light is returned to an extended configuration, the kill switch is deactivated and the light returns to the control of the switch or control device.

In some embodiments, a device of the present invention is a light, lighting element, light fixture, and/or lighting device. In some embodiments, a light is mounted or installed in/on an object. The present invention is not limited in scope by the type or style of the light, light fixture, bulb, lamp, light component, etc. to be used. In some embodiments, a device, light component, light fixture, etc. comprises one or more light emitting diodes (LEDs), halogen lamps, fluorescent lights, incandescent bulbs, compact fluorescent bulbs, etc. In some embodiments, a light component or fixture comprises a neck suitable for extending and retracting from a mounting object (e.g. furniture, vehicle, etc.). In some embodiments, a fixture comprises a gooseneck, flexible neck, bendable neck, and/or rotatable neck. In some embodiments, the neck enables any combination of rotation and bending. In some embodiments, the neck enables infinite adjustment of the angle and aim of the lights mounted thereon. In some embodiments, a neck is substantially rigid over its length. In some embodiments, a neck comprises one or more joints (e.g. 1, 2, 3, 4, 5 . . . 10, etc.) to allow angular adjustment at specified locations along the length of the neck. In some embodiments, a neck is configured to adopt one or more specified configurations upon extension. In some embodiments, a neck is configured to adopt a curved conformation along all or a portion of its length. In some embodiments, a neck is configured to adopt a straight conformation along all or a portion of its length. In some embodiments, all or a portion of the neck of a light fixture comprises a “flex neck.”

In some embodiments, the present invention provides a light, or other device, mounted in/on, or installed in/on an object, apparatus, or article of manufacture. In some embodiments, a light is mounted in/on a piece of furniture. In some embodiments, a light is mounted in/on seating (e.g. chair (e.g. work chair, easy chair, recliner dentist's chair, conference chair, etc.), theater seating, conference seating, stadium seating, etc.) table (e.g. coffee table, work surface, end table, conference table, etc.), couch, shelving, book case, etc. In some embodiments, the present invention provides seating (e.g. upholstered chairs and sofas) arrangements specifically designed for theater use, with integrated extendable lighting. In some embodiments, a light is mounted in any suitable portion of a piece of seating (e.g. couch, chair, theater seating, car seat, etc.) including, but not limited to: arm rest, head rest, center console, between two seats, within seating, etc. In some embodiments, the present invention provides vehicular seating for use in planes, trains, boat, cars, trucks, etc., with integrated extendable lighting.

In some embodiments, the housing component of a light of the present invention is configured to: (1) contain the light component when the light adopts a stowed, retracted, and/or concealed configuration; (2) allow extension of the light component from the housing in order to adopt an active, or extended configuration; (3) to comprise all or a portion of the switch component to power and depower the light component upon extension and retraction, respectively; and/or (4) mount the light fixture in/on an object (e.g. furniture, chair, etc.), device, and/or apparatus.

In some embodiments, the present invention is not limited by the means for mounting and/or integrating a device (e.g. light) in/on an object or apparatus (e.g. seating). In some embodiments, a base or housing provides a means for integrating the device (e.g. light) into the apparatus (e.g. seating). In some embodiments, a housing rests within an object or apparatus, with its top opening sitting near the surface of the apparatus or object. In some embodiments, housing sits within the object of apparatus with one end sitting flush (or nearly flush) with the surface of the apparatus or object (e.g. seating). In some embodiments, a housing provides a port-of-entry for a device (e.g. light) into an object or apparatus (e.g. seating). In some embodiments, a housing provides a means for concealing a device within an apparatus. In some embodiments, a housing provides a means (e.g. latch) for securing a device (e.g. light) into a stowed configuration. In some embodiments, a housing provides a means for containing a device (e.g. light) when in its stowed configuration. A housing provides a means for releasing a device (e.g. light) from a stowed configuration (e.g. spring and latch). In some embodiments, a housing provides a cover to conceal a device (e.g. light). In some embodiments, a cover is a portion of, or integrated into a portion of an object or apparatus (e.g. seating (e.g. arm rest, head rest, console, etc.)). In some embodiments, a cover holds a device in a concealed or retracted configuration. In some embodiments, a device (e.g. light) is mounted within a piece of furniture and is activated upon removing and/or moving a cover to reveal the device (e.g. light). In some embodiments, a device (e.g. light) is mounted in a stationary fashion in a piece of furniture and is activated by lifting up and/or pulling down a cover (e.g., mounted in the center of a couch and the head rest area of the center section is flipped up exposing the light and turning it on). In some embodiments, a device (e.g. light) is inactive when concealed by a cover (e.g. lid, arm rest, seat cushion, panel, etc.), and is activated when the cover is moved to reveal the device (e.g. light). In some embodiments, a device (e.g. light) is stationary and/or moveable (e.g. extendable, retractable, bendable, etc.).

In some embodiments, the present invention is not limited by the location or means for mounting and/or integrating a device (e.g. light) in/on an object or apparatus (e.g. seating). In some embodiments, a device (e.g. light) is completely obscured from view when adopting a concealed and/or inactive conformation (e.g. concealed by a cover). In some embodiments, a device (e.g. light) is revealed and/or activated by extending the device (e.g. light) from a housing and/or its mounted location on an object or apparatus (e.g. seating (e.g. arm rest, head rest, console, car door, overhead console, dashboard, etc.)). In some embodiments, a device (e.g. light) is revealed and/or activated moving and/or removing a cover. In some embodiments, moving a cover that conceals a device (e.g. light) activates the device (e.g. light). In some embodiments, moving a cover to reveal a device (e.g. light) allows the device to be extended (e.g. automatically or manually). In some embodiments, a cover comprises a portion of the object or apparatus within which the device (e.g. light) is mounted, for example, an arm rest top, seat cushion, head rest, console top, etc. In some embodiments, a portion of a device (e.g. light) is visible when in a concealed, retracted, and/or inactive configuration (e.g. to provide user-access to the device (e.g. to extend and/or activate the device).

In some embodiments, a sensor and/or switching mechanism of the present invention is configured to automatically activate and/or deactivate a device (e.g. light). In some embodiments, the sensor and/or switching mechanism is configured to function in response to changes in the conformation of the device (e.g. extended or retracted), and/or changes in the conformation of a cover for the device (e.g. open or closed). In some embodiments, a first portion of a sensor and/or switching mechanism is mounted on a cover and a second portion is mounted on the device (e.g. light) or housing. In some embodiments, as a cover is closed, the sensor and/or switching mechanism indicates that the light be turned off or deactivated. In some embodiments, as a cover is opened, the sensor and/or switching mechanism indicates that the light be turned on or activated.

The present invention is not limited by the mechanism for moving a device (e.g. light) between its stowed and extended configurations. In some embodiments, a device is manually extended and refracted. In some embodiments, a mechanical device (e.g. spring, crank, pulley, chain, gear, etc.) provides energy to extend or retract a device from its housing. In some embodiments, the present invention provides automated retraction and extension of a device from its housing (e.g. motor driven retraction and/or extension). In some embodiments, a device automatically extends following disengagement of a mechanism holding the device in a retracted or inactive configuration. In some embodiments, a device automatically extends following removal of a cover.

### EXAMPLES

### Example 1

### In-Chair Light

In some embodiments, the present invention provides a recliner chair (e.g. for use in a home theater setting). The chair may provide numerous amenities including, but not limited to: foot rest, back massage, build-in remote control, cup holders, etc. In addition to other features and amenities, a retractable and flexible light fixture is installed within the arm rest of the chair. The light fixture comprises several LEDs mounted upon the head of the fixture, at the end of a bendable neck. The neck is radially flexible along its entire length, and capable of maintaining a bent confirmation without external or user support. The light fixture is capable of adopting a stowed configuration in which the entire length of the neck and head of fixture is retracted through the light housing and stowed within the arm of the chair. When the light is retracted into the stowed configuration, only the top of the head is visible and/or accessible. The light fixture is held in the retracted configuration by a spring-and-latch mechanism. Upon fully depressing the light into the arm of the chair, a latch on the light housing engages the fixture, holding the fixture in the stowed configuration. In the stowed configuration, the top of the head of the light is flush with the top of the housing and the top of the arm rest of the chair. Upon depressing the head of the stowed and latched light fixture, the latch un-engages with the light fixture and the spring causes the light to extend slightly (e.g. 0.5-4 inches) above the surface of the arm rest and housing. A user is able to grasp the unlatched and spring-extended light fixture, and the user can manually extend it to a desired length and bend the neck into a desired conformation. When the user is done with the light, the light is again depressed into the housing on the arm of the chair. The top of the head is pressed just below the surface of the arm rest, against the pressure of the spring, to engage the latch and return the light to its stowed configuration.

In addition to the spring-and-latch mechanism, the light fixture is equipped with an automatic on/off switch sensor. Upon fully retracting the light into the stowage conformation, the light is automatically turned off. When the fixture is released from the latch, and even partially extended from the arm rest, the switch or sensor turns the light on. The user only performs the steps necessary to extend or retract the fixture, and the switch/sensor automatically turns the light on/off. The automatic switch ensures that the light is on when extended from the arm rest, and that the light is off when stowed. By automatically turning the light off upon stowage, the automatic switch/sensor reduces fire risk and energy expenditure.

The embodiments and features described in this example find use in combination with other devices and features described herein. For example, a retractable light and proximity sensor may be installed in another type of chair, in a vehicle, or in another object. The on/off switch sensor is of any type described herein or understood by one of skill in the field (e.g. proximity sensor, Hall-Effect sensor (Example 2), IR sensor (Example 3), inclinometer, etc.). The above example should be viewed as exemplary and not as limiting the scope of the invention.

### Example 2

### Hall-Effect Sensor

In some embodiments, the in-chair light of Example 1 comprises a Hall-Effect device functioning as an on/off switch. A Hall-Effect device is located on the head of the light fixture, and a magnet is mounted on the housing of the light fixture. When the fixture is placed in the stowed configuration, the Hall-effect device and the magnet are brought into close proximity causing the Hall-Effect device output voltage difference .to de-activate the a solid state device to turn the light OFF. When the fixture is released from the latch mechanism, thereby raising the light above the level of the arm rest, the magnet and Hall-Effect Device are brought outside of the minimum threshold distance, and the Hall-Effect device sends and electric signal to turn on the light. The switch works without any mechanical movements. When the magnet and the Hall-Effect Device cross the threshold distance, the appropriate signal is sent to turn the light on or off.

Alternative configurations and uses of Hall-effect device find use in the present invention. For example the mounting of the Hall-Effect device and magnet can be switched, or alternative mounting positions can be used. The means of operating a Hall-Effect device in the above example should not be viewed as limiting the scope of the present invention.

### Example 3

### IR Sensor

In some embodiments, the in-chair light of Example 1 comprises an infrared sensor functioning as an on/off switch. An IR transmitter is located on the housing of the light fixture, and an IR receiver is located on the housing of the light fixture. The transmitter and receiver are aligned such that when the light fixture is in the stowed configuration the IR receiver detects signals from the IR transmitter. Upon detecting the IR signal, the receiver initiates depowering of the light. As long as the light fixture is in the recessed position, the IR signal is transmitted and the light remains off. Upon extension of the light fixture out of the light housing, the IR transmitter and IR receiver become unaligned, and the receiver is no longer capable of detecting the signal from the transmitter. Once the signal connection between the transmitter and receiver is broken, power flow is restored to the light fixture, thereby allowing the light to be turned on. In some embodiments, restoring power results in turning the light on, while in other embodiments, restoring power provides conditions such that a user can turn on the light via another switch. In either case, when the IR signal connection is complete, the light is off, and cannot be turned on.

Alternative configurations and uses of an IR sensor find use in the present invention. For example the mounting of the transmitter and receiver can be switched, or alternative mounting positions can be used. In some embodiments, a broken IR signals a stowed light, rather than an extended one. The means of operating an IR sensor in the above example should not be viewed as limiting the scope of the present invention.

All publications and patents mentioned in the present application and/or listed below are herein incorporated by reference. Various modification, recombination, and variation of the described features and embodiments will be apparent to those skilled in the art without departing from the scope and spirit of the invention. Although specific embodiments have been described, it should be understood that the invention as claimed should not be unduly limited to such specific embodiments. Indeed, various modifications of the described modes and embodiments that are obvious to those skilled in the relevant fields are intended to be within the scope of the following claims.

We claim:

1. A stowable light fixture comprising:
a) a housing component;
b) a light component, wherein said light component is configured to adopt:
i) a stowed configuration in which said light component is contained within said housing, and
ii) an active configuration in which said light component is extended from said housing; and
c) a switch component, wherein said switch component is configured to:
i) depower said light component when said light component adopts a stowed configuration, and
ii) activate said light component when said light component adopts an active configuration.

2. The stowable light fixture of claim 1, wherein said switch component is selected from a group comprising a Hall-Effect device, proximity sensor, optical sensor, audio sensor, IR sensor, inclinometer, and accelerometer.

3. The stowable light fixture of claim 1, wherein said switch component does not comprise a mechanical switch.

4. The stowable light fixture of claim 1, wherein depowering said light component upon stowage turns off said light component.

5. The stowable light fixture of claim 4, wherein activating said light component upon extension from said housing component turns on said light component.

6. The stowable light fixture of claim 4, wherein powering said light component upon extension from said housing component enables said light component to be turned on and off by another device.

7. The stowable light fixture of claim 1, wherein said housing component is configured for integration into an object.

8. The stowable light fixture of claim 7, wherein said object is furniture or a vehicle.

9. The stowable light fixture of claim 8, wherein said object is a vehicle.

10. An apparatus comprising:
(a) a light, wherein said light is configured to adopt a stowed configuration within said apparatus and an active configuration extended from said apparatus; and
(b) a configuration-dependent switch, wherein said configuration-dependent switch depowers said light upon adopting said stowed configuration.

11. The apparatus of claim 10, wherein depowering said light comprises turning off said light.

12. The apparatus of claim 10, wherein said configuration-dependent switch activates said light upon adopting said active configuration.

13. The apparatus of claim 10, wherein activating said light comprises turning on said light.

14. The apparatus of claim 10, wherein said apparatus is a piece of furniture.

15. The apparatus of claim 14, wherein said piece of furniture selected from a group comprising a chair, couch, theater seating, table, shelf, or book case.

16. The apparatus of claim 10, wherein said apparatus is a vehicle.

17. The apparatus of claim 16, wherein said vehicle is selected from a group comprising a car, truck, plane, boat, or train.

18. The apparatus of claim 10, wherein said configuration-dependent switch is selected from a group comprising a mechanical switch, Hall-Effect device, proximity sensor, optical sensor, audio sensor, IR sensor, inclinometer, or accelerometer.

19. The apparatus of claim 10, wherein said configuration-dependent switch does not comprise a mechanical switch.
